(19) United States
(12) Patent Application Publication
(10) Pub. No.: US 2014/0001387 A1
(43) Pub. Date: Jan. 2, 2014

(54) DRIVE DEVICE FOR A VALVE, VALVE FOR CONTROLLING A GAS AND/OR LIQUID FLOW

(71) Applicants: Ralf Schuler, Wichtshausen (DE); Gunter Schmid, Nurnberg (DE)

(72) Inventors: Ralf Schuler, Wichtshausen (DE); Gunter Schmid, Nurnberg (DE)

(73) Assignee: Schaeffler Technologies AG &Co.KG

(21) Appl. No.: 14/005,397

(22) PCT Filed: Mar. 12, 2012
(86) PCT No.: PCT/EP2012/054199

§ 371 Date: Sep. 16, 2013

(30) Foreign Application Priority Data
Mar. 24, 2011 (DE) 102011006071.5

(51) Int. Cl. F16K 31/06; F16K 37/00

(52) U.S. Cl. CPC F16K 31/0658; F16K 37/00
USPC 251/129.15; 137/553

(57) ABSTRACT

A drive device (10) for a valve (1), to a valve (1) for controlling a gas and/or liquid flow (40), and a system (60) for controlling a medium (40). The drive device (10) has a housing (11) for accommodating a coil (17d), which is fixed with respect to the housing (11), and a drive rod (14), on which a pole shoe (15d) and a permanently-magnetic element (16c) that is magnetized, or a soft-magnetic element (16c) that can be magnetized, in the axial direction of the drive rod (14) are attached such that the drive rod (14) can be moved with a translational motion relative to the coil (17d) by magnetic force. The drive rod (14) can be coupled to a shut-off body (33) of the valve (1) that can be moved with a translational motion such that a translational motion of the drive rod (14) affects a translational motion of the shut-off body (33) for opening and closing the valve (1).

### FIELD OF THE INVENTION

The invention relates to a drive device for a valve and to a valve for controlling a gas flow and/or a liquid flow.

### BACKGROUND

Conventionally, valves with a shut-off body rod are known which include a shut-off body, such as a piston, a ball, etc., being mounted on one end of this rod. If the shut-off body rod is moved back and forth in a translational motion, the valve can be either opened or closed. Such valves are used, for example, for controlling gas flows or liquid flows in a pipe, etc.

FIG. 4 shows an example for a known valve 100 that comprises a pneumatic cylinder 110 and a valve block 120 and is used for controlling a gas flow or liquid flow.

The pneumatic cylinder 110 comprises a piston 111 that is mounted on one end of a pneumatic cylinder piston rod 112, two air inlet holes 113, and two damping elements 114. The two air inlet holes 113 are arranged one above the other in FIG. 4. Compressed air 115 can be blown into the pneumatic cylinder 110 through the lower air inlet hole 113. Each of the two damping elements 114 is arranged at one of two end positions E1, E2 of the piston 111. The piston 111 and thus the pneumatic cylinder piston rod 112 mounted to it can be moved back and forth in a translational motion between these positions by the compressed air 115.

The valve block 120 has a valve block piston rod 121, a valve tappet 122, a valve seat 123, a medium inlet opening 124, a medium outlet opening 125, and a compression spring 126.

The valve block piston rod 121 is coupled with the pneumatic cylinder piston rod 112 such that a translational motion of the pneumatic cylinder piston rod 112 also causes a translational motion of the valve block piston rod 121. For this purpose, the compression spring 126 is installed in the valve block 120 such that, in the uncompressed state, that is, when the pneumatic cylinder 110 is not charged with compressed air 115, the valve tappet 122 contacts the valve seat 123 and thus closes the medium outlet opening 125 and thus the valve 100. If the pneumatic cylinder 110 is charged with compressed air 115 through the air inlet hole 113, then the valve tappet 122 is lifted from the valve seat 123 and thus the valve 100 opens. Therefore, a medium 130 flowing into the medium inlet opening 124 (e.g., gas and/or liquid) can flow via the medium outlet opening 125 into the reservoir 140 arranged underneath. As soon as the reservoir 140 is sufficiently filled with the medium 130, the valve 100 can be closed again.

The pneumatic cylinder 110 is thus a single-acting cylinder that is actuated by compressed air 115 in one direction and is actuated in the second direction by the compression spring 126 in the uncompressed state.

Disadvantages in such a pneumatically actuated valve 100 are that the switching time is relatively long at approx. 0.1 to 0.3 seconds, loss of compressed air and thus energy occurs continuously with each switching cycle, and only two end positions E1, E2 are possible. Controlled movement of the valve tappet is not possible between the two end positions E1, E2, that is, a medium-dependent stroke-time cycle cannot be adjusted and regulated, because the piston of the pneumatic cylinder 110 moves between the two end positions E1, E2 at an arbitrary speed.

It is also disadvantageous for a pneumatic drive for a valve that leaks can result at different points in the compressed air supply. Because such leaks are usually not detected immediately or only with difficulty, this can lead to a permanent loss of compressed air and energy.

Special stroke magnets are known from DE 41 28 983 A1, DE 10 2007 034 768 B3, DE 10 2007 053 005 A1, and DE 20 2007 015 492 U1. With such stroke magnets or magnetic cylinders, the force-stroke characteristic curve is generally strongly degressive or strongly progressive, so that the axial force rises or falls significantly over the stroke displacement. The range of the stroke in which a significant axial force can be used is very limited and short. For this reason, such stroke magnets are less suitable for valves with a shut-off body rod as described above.

Therefore, the objective of the invention is to provide a drive device for a valve and a valve for controlling a gas flow and/or liquid flow that can eliminate the disadvantages of the prior art mentioned above and have, with reference to the valve, freely programmable end positions, a freely selectable and controllable motion profile, a highest possible force output (large stroke displacement and high shut-off body rod force for minimal installation space requirements), short switching times, reduced energy consumption, low maintenance requirements, and long service life.

The objective is met by a drive device for a valve according to the invention that comprises a housing for holding a coil and a drive rod. The coil is stationary with respect to the housing. A pole shoe and a magnetized, permanently magnetic or magnetizable, soft-magnetic element are mounted on the drive rod such that the drive rod can be moved with a translational motion relative to the coil by a magnetic force. Here, the drive rod can be coupled with a shut-off body of the valve that can move with a translational motion such that a translation motion of the drive rod causes a translational motion of the shut-off body for opening and closing the valve.

Additional advantageous constructions of the drive device are disclosed in the dependent claims.

Advantageously, the housing is equipped for holding a metal part that is mounted on the housing and surrounds the coil and another coil arranged alongside, wherein the coils are mounted on the metal part and each of these coils has at least one winding, with the directions of these windings being opposite each other. Here, the pole shoe, another pole shoe, and the element that is magnetized and permanently magnetic or magnetizable and soft-magnetic in the axial direction of the drive rod is mounted on the drive rod such that the drive rod can be moved with a translational motion into and along the coils by means of magnetic force.

The drive device can produce a stroke of the drive rod from the length of the coil in the longitudinal direction of the drive rod minus the thickness of the pole shoe in the longitudinal direction of the drive rod.

In addition, the drive device can also comprise another permanently magnetic or soft-magnetic element that is arranged at a predefined distance from the pole shoe and permanently magnetic or soft-magnetic element on the drive rod and another soft-magnetic element that surrounds the additional permanently magnetic or soft-magnetic element.

The housing is preferably constructed so that it is sealed against the ingress of liquid and/or gas from the outside.

It is possible that the permanently magnetic or soft-magnetic element, the two pole shoes, and the additional permanently magnetic or soft-magnetic element are arranged on the drive rod with axis symmetry relative to the drive rod.

Furthermore, the drive device can have a measurement device for measuring a translational motion performed by the drive rod in the housing, wherein the measurement device is arranged on the end of the drive rod facing away from a coupling with the shut-off body.

It is also advantageous if the housing is also constructed for holding a control device for connecting to a bus line by means of which the control device can receive data for controlling and/or regulating the drive device.

The previously mentioned problem is also solved by a valve for controlling a gas flow and/or liquid flow that has a shut-off body that can be moved with a translational motion and is coupled with a drive rod of the previously described drive device such that a translational motion of the drive rod causes a translational motion of the shut-off body for opening and closing the valve.

The construction of the drive device as described above makes possible both freely programmable end positions and a controlled movement profile of a valve equipped with the drive device. Here, the movement profile can be specified by an operator as a function of the type of medium (e.g., glass or liquid) and can be preset in the controller or control device.

In addition, due to the previously described construction of the drive device that reliably protects sensitive components of the drive device from harmful environmental influences, namely, for example, disinfecting and cleaning agents, moisture, dust, and shocks. This is very advantageous because the disinfecting and cleaning agents are generally aggressive acids or bases, so that the drive device and the valve are exposed to very adverse environmental conditions. In addition, the drive device and the valve can also operate reliably at high environmental temperatures. This results overall in a long service life for the drive device and the valve.

Furthermore, the previously described drive device can manage completely without lubricants and it exhibits no friction and no wear, so that environmental contaminants can be completely ruled out.

In addition, in the drive device, associated control electronics can also be integrated by means of the control device, so that any individual drive device can be driven individually by means of a bus line. This increases the dynamic response of the switching process and the accuracy and also reduces the energy consumption of the drive device.

As an additional advantage of the previously described construction of the drive device, the wiring complexity can be minimized, because it is possible to use electronic bus systems, for example, CANopen, Ethernet, EtherCAD, Profibus, etc.

In addition, a large stroke displacement and a large piston rod force are achieved by means of the previously described drive device for minimal installation space requirements. That is, a valve equipped with the drive device has a high force output.

### BRIEF DESCRIPTION OF THE DRAWINGS

The invention is described in more detail below using embodiments with reference to the accompanying drawings. Shown are:

FIG. 1 a schematic diagram of a valve with a drive device according to a first embodiment of the invention,

FIG. 2 a schematic diagram of a part of the drive device according to a first embodiment of the invention for calculating the stroke of the valve,

FIG. 3 a system with a valve according to a first embodiment of the invention, and

FIG. 4 a schematic diagram of a valve according to the prior art.

### DETAILED DESCRIPTION OF THE PREFERRED EMBODIMENTS

Identical reference symbols are used for elements that are identical or have an identical action. The illustrated embodiments merely represent examples how the drive device according to the invention and the valve according to the invention could be equipped. They do not represent a conclusive restriction of the invention.

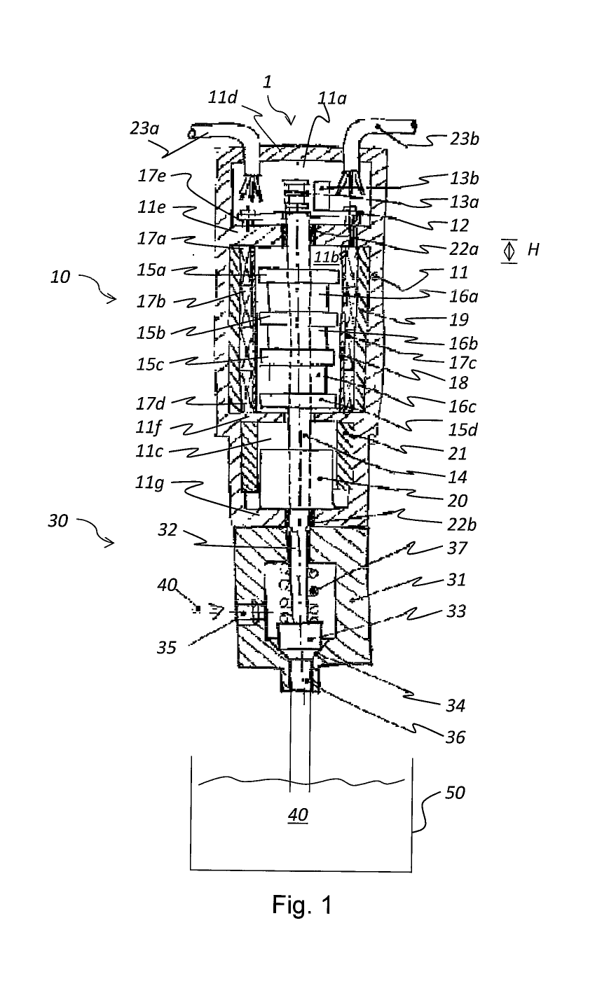

In a first embodiment of the invention, FIG. 1 shows a valve 1 for controlling a gas flow and/or liquid flow, wherein this valve can be a valve for controlling a gas flow and/or liquid flow in a pipe. The valve 1 has a drive device 10 and a valve block 30.

The drive device 10 has a housing 11 in which are housed a control device 12 for controlling a drive force generated by the drive device 10, a measuring device 13a, 13b, a drive rod 14, a first to fourth pole shoe 15a, 15b, 15c, 15d, a first to third permanently magnetic element 16a, 16b, 16c, a first to fourth coil 17a, 17b, 17c, 17d with electric connection lines 17e, a coil carrier 18, a metal part 19, another permanently magnetic element 20, a soft-magnetic element 21, and a first and second bearing 22a, 22b for supporting the drive rod 14 in and on the housing 11. A first and second electrical line 23a, 23b are inserted into the housing 11. The drive device 10 can be provided with electrical energy via these lines and can be connected to a controller of a higher level system that is not shown here.

The housing 11 is divided in FIG. 1 into a first housing space 11a, a second housing space 11b, and a third housing space 11c. The first housing space 11a borders the second housing space 11b. The second housing space 11b borders the third housing space 11c. The second housing space 11b thus lies between the first and third housing space 11a, 11c. The first housing space has an outer wall 11d that is arranged at the very top in FIG. 1 and also bounds the first housing space 11a on one side. Between the first and second housing space 11a, 11b there is a housing intermediate wall 11e. Between the second and third housing space 11b, 11c there is a housing intermediate wall 11f. In addition, the housing 11 borders the valve block 30 with one outer wall 11g. The outer wall 11g also bounds the third housing space 11c on one side.

In the first housing space 11a, the control device 12 and the measuring device 13a, 13b are held. On one side of the first housing space 11a that corresponds to the outer wall 11d of the housing 11, the first and second electrical lines 23a, 23b project with one of their ends, that is, partially, into the first housing space 11a. On the side of the first housing space 11a opposite the outer wall 11d of the housing 11 or on the side of the housing intermediate wall 11e, the drive rod 14 projects with one of its two ends, that is, partially, into the first housing space 11a. In addition, the electrical connection lines 17e lead through the housing intermediate wall 11e in order to connect the coils 17a, 17b, 17c, 17d to the control device 12.

In the second housing space 11b are housed the first to fourth pole shoe 15a, 15b, 15c, 15d, the first to third permanently magnetic element 16a, 16b, 16c, the first to fourth coil 17a, 17b, 17c, 17d on the coil carrier 18, and the metal part 19. In contrast, the drive rod 14 leads completely through the second housing space 11b. Here, the drive rod 14 is supported in the housing intermediate wall 11e by means of the first bearing 22a so that it can be moved with a translational motion, while it projects into the third housing space 11c through an opening in the housing intermediate wall 11e without a support.

In the third housing space 11c are housed the additional permanently magnetic element 20 and the soft-magnetic element 21. In contrast, the drive rod 14 also leads completely through the third housing space 11c. Here, the drive rod 14 is supported in the outer wall 11g of the housing 11 bordering the valve block 30 by means of the second bearing 22b so that it can move with a translational motion.

Due to the translational support of the drive rod 14 by the first and second bearing 22a, 22b, the drive rod 14 can be raised and lowered or moved back and forth by a stroke H as shown in FIG. 1 via an arrow with two ends. For this purpose, on the drive rod 14 in the second housing space 11b, the first to fourth pole shoe 15a, 15b, 15c, 15d and the first to third permanently magnetic element 16a, 16b, 16c are each arranged alternating one next to the other such that advantageously there is no space between them. In other words, the first pole shoe 15a, the first permanently magnetic element 16a, the second pole shoe 15b, the second permanently magnetic element 16b, the third pole shoe 15c, the third permanently magnetic element 16c, and the fourth pole shoe 15d are arranged one next to the other in this sequence. Here, in FIG. 1, the first pole shoe 15a is arranged as the uppermost component of this sequence and the fourth pole shoe 15d is arranged as the lowermost component of this sequence. In addition, the first coil 17a is arranged as a ring around the first pole shoe 15a. The second coil 17b is arranged as a ring around the second pole shoe 15b. The third coil 17c is arranged as a ring around the third pole shoe 15c. And the fourth coil 17d is arranged as a ring around the fourth pole shoe 15d. The first to fourth coils 17a, 17b, 17c, 17d are arranged, advantageously without spacing, one next to the other on the coil carrier 18 that is in turn arranged between the coils 17a, 17b, 17c, 17d and the assembly that is formed from pole shoes 15a, 15b, 15c, 15d and the permanently magnetic elements 16a, 16b, 16c on the drive rod 14.

The coil carrier 18 is constructed in FIG. 1 as a pipe and is used for carrying, supporting, and protecting the coils 17a, 17b, 17c, 17d. The coils 17a, 17b, 17c, 17d are wound directly on the coil carrier 18. The coils 17a, 17b, 17c, 17d are connected electrically in series and each have at least one winding, wherein the at least one winding is wound alternately in the counterclockwise direction (cc) and in the clockwise direction (cw) with reference to the adjacent coils. On both ends of the coil assembly formed by the coils 17a, 17b, 17c, 17d there is only one single connection line 17e, for example, a wire, by means of which the coil assembly formed on the coil carrier 18 is coupled electrically with the control device 12, as shown in FIG. 1.

On the side of the coils 17a, 17b, 17c, 17d facing away from the coil carrier 18 there is the metal part 19 around the coils 17a, 17b, 17c, 17d. In other words, the metal part 19 is also constructed as a pipe in FIG. 1. The metal part 19 is mounted on the housing 11. In addition, the coils 17a, 17b, 17c, 17d or the coil carrier 18 are mounted on the metal part 19 and/or the housing 11. Consequently, the first to fourth coils 17a, 17b, 17c, 17d of the coil carrier 18 and the metal part 19 are also arranged around the permanently magnetic elements 16a, 16b, 16c and the drive rod 14.

Between the coil carrier 18 and the assembly made from pole shoes 15a, 15b, 15c, 15d and permanently magnetic elements 16a, 16b, 16c on the drive rod 14 there is a spacing such that the drive rod 14 can move with a translational motion by the stroke H with the assembly made from pole shoes 15a, 15b, 15c, 15d and permanently magnetic elements 16a, 16b, 16c relative to the stationary coil carrier 18. If the pole shoes 15a, 15b, 15c, 15d have a larger outer extent than the permanently magnetic or soft-magnetic elements 16a, 16b, 16c, as shown in FIG. 1, the spacing between the pole shoes 15a, 15b, 15c, 15d and the coil carrier 18 must be dimensioned so that the drive rod 14 can move with a translational motion by the stroke H with the assembly made from pole shoes 15a, 15b, 15c, 15d and permanently magnetic elements 16a, 16b, 16c relative to the stationary coil carrier 18.

The metal part 19, the series of coils 17a, 17b, 17c, 17d arranged one next to the other, and the coil carrier 18 are adapted in their length or height to the length of the second housing space 11b. In other words, the metal part 19 and the coil carrier 18 are, in FIG. 1, approximately the same height or somewhat shorter than the length of the second housing space 11b and the series of coils 17a, 17b, 17c, 17d arranged one next to the other is approximately the same length or somewhat shorter than the length of the second housing space 11b. The metal part 19 is advantageously made from a magnetizable metal, for example, iron, and is used as a metal or iron back network.

The first to third permanently magnetic elements 16a, 16b, 16c are each magnetized in the axial direction, that is, in the axial direction of the drive rod 14, the vertical direction in FIG. 1. In addition, the drive rod 14, the first to fourth pole shoe 15a, 15b, 15c, 15d and the first to third permanently magnetic element 16a, 16b, 16c have a rotationally symmetric construction. Therefore, an anti-rotation device is not required for these components.

The measuring device 13a, 13b comprises a solid measure 13a that is formed of two grooves in the drive rod 14 and a detecting device 13b for detecting the position or location of the solid measure 13b. For this purpose, the detecting device 13b is arranged in FIG. 1 facing the solid measure 13b. The position of the drive rod 14 detected by the detecting device 13b can be forwarded by means of the first and/or second electrical lines 23a, 23b inserted into the housing 11 to the control device 12 and/or a higher level controller and/or control device not shown here. Based on the detected position, the control device 12 and/or the higher level controller and/or control device can regulated or control the drive device 10 as desired. The drive device 10 can also be supplied with electrical energy via the first and/or second electrical line 23a, 23b.

If an electrical voltage is applied to the coils 17a, 17b, 17c, 17d so that the coils 17a, 17b, 17c, 17d carry an electrical current, a magnetic field forms around the windings of each coil 17a, 17b, 17c, 17d, and due to this magnetic field, the arrangement made from pole shoes 15a, 15b, 15c, 15d and permanently magnetic elements 16a, 16b, 16c is pulled upward in FIG. 1. As a function of the intensity and course of the current flowing in the coils 17a, 17b, 17c, 17d, the arrangement made from pole shoes 15a, 15b, 15c, 15d and permanently magnetic elements 16a, 16b, 16c is pulled quickly or slowly and all the way or only part of the way upward. In the position of the drive rod 14 shown in FIG. 1, the coils 17a, 17b, 17c, 17d are not carrying an electrical current, so that the lowermost pole shoe 15d is located in its lowermost position.

In the third housing space 11c, the additional permanently magnetic element 20 is also mounted, for example, plugged onto the drive rod 14. The additional permanently magnetic element 20 is magnetized in the axial direction. The soft magnetic element 21 has a ring-shaped construction in FIG. 1, for example, as a pipe, which surrounds the additional permanently magnetic element 20. Due to the magnetic force of attraction between the additional permanently magnetic element 20 and the soft-magnetic element 21, the additional permanently magnetic element 20 is pulled into the soft-magnetic element 21. This arrangement produces an action of force that is directed opposite the direction of the weight of the components or assembly on the drive rod 14 and the spring pretensioning of the valve 1 described below and at least partially compensates for these forces.

The valve block 30 in FIG. 1 has a valve block housing 31, a shut-off body rod 32, a shut-off body 33, a valve seat 34, a medium inlet opening 35, a medium outlet opening 36, and a compression spring 37.

The shut-off body rod 32 is coupled to the drive rod 14 of the drive device 10 such that a translational motion of the drive rod 14 also causes a translational motion of the shut-off body rod 32. In the valve block 30, the drive rod 14 and the shut-off body rod 32 of the valve 1 are coupled by means of a passage hole in a wall of the valve block housing in which the drive rod 14 contacts the shut-off body rod 32 and they are fastened to each other. In addition, the compression spring 37 is installed in the valve block 30 such that, in the non-compressed state, that is, when no current is flowing in the coils 17a, 17b, 17c, 17d, the shut-off body 33 contacts the valve seat 34 and thus the medium outlet opening 36 and thus the valve 1 closes. Conversely, if a current is flowing in the coils 17a, 17b, 17c, 17d, then the shut-off body 33 is lifted from the valve seat 34 and thus the valve 1 opens at least partially or even completely. The opening of the valve 1 is thus dependent on the intensity of the current flowing in the coils 17a, 17b, 17c, 17d. Therefore, a medium 40 (e.g., gas and/or liquid) flowing into the medium inlet opening 35 can flow via the medium outlet opening 36 into the reservoir 50 arranged underneath. As soon as the reservoir 50 is filled sufficiently with the medium 40, the valve 1 can be closed again.

For the function described above, the drive device 10 shown in FIG. 1 requires, at a minimum, one of the coils 17a, 17b, 17c, 17d with at least one winding that is stationary relative to the housing 11 and the drive rod 14 on which one of the pole shoes 15a, 15b, 15c, 15d and a permanently magnetic element magnetized in the axial direction of the drive rod 14 are mounted such that the drive rod 14 can move by means of magnetic force with a translational motion relative to the one coil of the coils 17a, 17b, 17c, 17d.

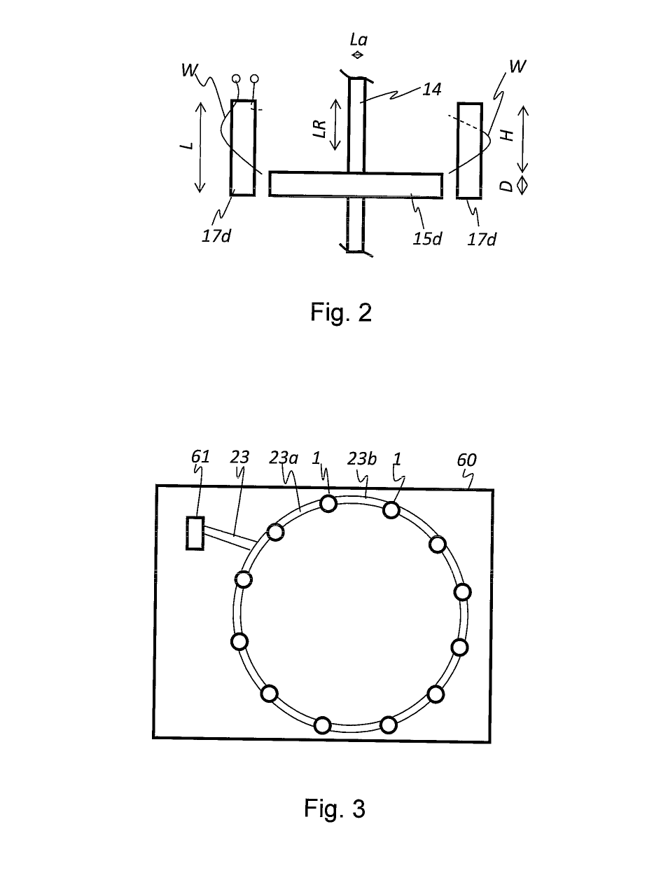

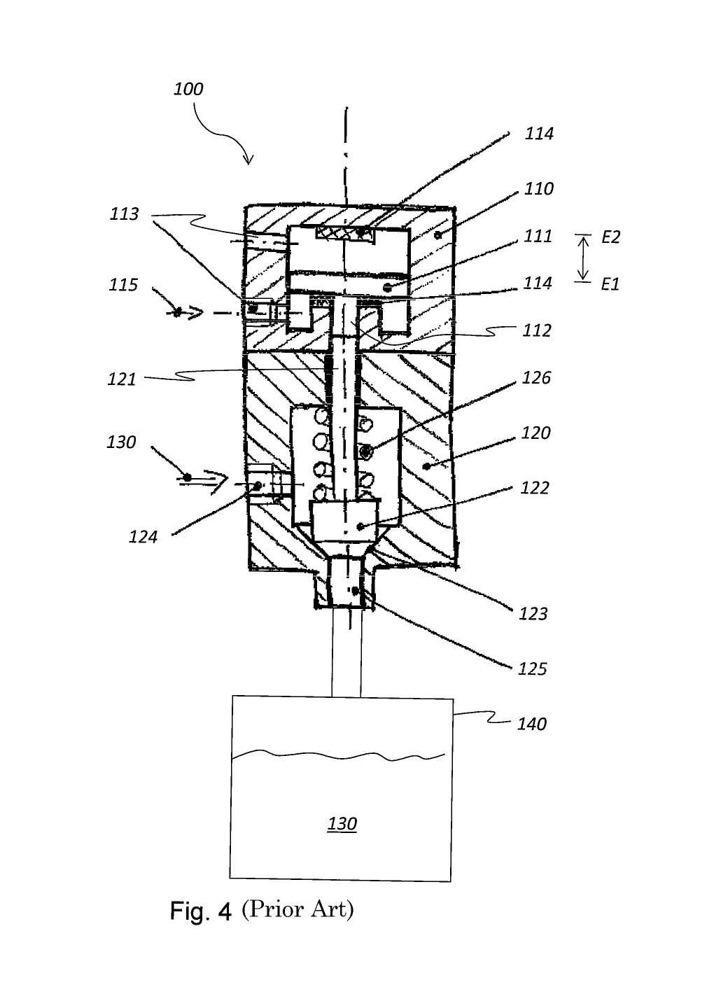

FIG. 2 shows parts of the drive device 10 of FIG. 1 that are required for explaining the calculation of the achievable stroke H of the drive rod 14. That is, in FIG. 2, the coil 17d is shown in section and the pole shoe 15d on the drive rod 14 is shown enlarged relative to the illustration in FIG. 1. The following constructions apply accordingly also for the other coils 17a to 17c and the pole shoes 15a to 15c, even if these are not named here.

In FIG. 2, the coil 17d has a length L and a winding W that is not shown in the area of drive rod 14 and pole shoe 15d for simplifying the illustration. The longitudinal direction of the drive rod 14 is designated with LR and the pole shoe 15d has a thickness D. Thus, the achievable stroke H of the drive rod 14 is given as the length L of the coil 17d that is shown in FIGS. 1 and 2 in the vertical direction (corresponds to the longitudinal direction LR of the drive rod 14) minus the thickness D of the pole shoe 15d that is also shown in FIGS. 1 and 2 in the vertical direction. The usable stroke extends to a pole step that is defined by the coil length minus the pole shoe width that is shown in FIGS. 1 and 2 in the horizontal direction.

The previously described drive device 10 is a permanently magnetically excited magnetic cylinder that is used for driving the valve block 30 instead of the described pneumatic cylinder of the prior art. The magnetic cylinder can be controlled and regulated in a simple way with the help of common servo boosters. Through the use of permanently magnetic elements 16a, 16b, 16c, the efficiency of the drive device 10 is high and thus its required installation volume is small. Furthermore, the stroke H in which the axial force of the permanently magnetic elements 16a, 16b, 16c can be used is also long and the axial force profile over the stroke H is essentially constant.

The control device 12 and the measuring device 13a, 13b are indeed separated by the previously described arrangement into two different housing spaces 11a, 11b from the coils 17a, 17b, 17c, 17d on the coil carrier 18 and the metal part 19, but these form one drive unit because they are all housed compactly in a single housing 11. Through suitable sealing of the passages of the electrical lines 23a, 23b and the drive rod 14 through the outer walls 11d and 11g of the housing 11, the drive unit or the whole drive device 10 can be protected from the ingress of gas and/or liquid from the outside. Thus, the drive unit or the whole drive device 10 can be protected from harmful environmental effects.

FIG. 3 shows schematically a top view of a system 60 with a control and/or regulation device 61 and a plurality of valves 1, wherein, in FIG. 3, only one part of the valves 1 is provided with a reference symbol. The valves 1 are arranged relative to each other in a circle in the system 60 and with a predetermined spacing that is preferably equal between all valves 1. The valves 1 are each connected to each other by electrical lines 23a, 23b, even if only two of the lines 23a, 23b are marked in FIG. 3. The lines 23a, 23b can form or comprise a bus line or a bus system, for example, CANopen, Ethernet, EtherCAD, Profibus, etc., for transmitting data between the individual valves 1 and the control and/or regulation device 61. The lines 23a, 23b can also be used as power supply lines or can comprise such power supply lines. That is, lines 23a, 23b or the bus lines and the power supply lines are continued from one valve 1 or its drive device 10 to a different valve 1 or its drive device 10. Therefore, the wiring expense is significantly minimized relative to a single wire between each individual valve 1 and the control and/or regulation device 61.

In the previously described first embodiment, typical switching cycles for the valve 1 are dependent on the required output power. The switching cycles equal, for example, up to ca. 100 strokes per minute. Here, preferably a freely programmable stroke displacement of 0 mm to 25 mm can be realized. Driving voltages can be low voltages of 24 or 48 volts or the like. This produces a thermal loss power of approx. 50 watts.

Typical environmental temperatures can be up to +90° C. As the protection class for protecting against contact with the voltage-carrying parts and against ingress of moisture, preferably the pressurized-jet water-tight protection class is selected.

According to a second embodiment of the invention, in the drive device 10 of the valve 1 of FIGS. 1 to 3, instead of the permanently magnetic elements 16a, 16b, 16c, a soft-magnetic element is used, for example, a soft iron core. Here, however, the effectiveness of the drive device 10 according to the second embodiment is not as high as in the first embodiment, i.e., magnetic cylinders with soft-magnetic elements between the pole shoes 15a, 15b, 15c, 15d require significantly larger installation space for the same mechanical output power.

According to a third embodiment of the invention, in the drive device 10 of the valve 1 of FIGS. 1 to 3, instead of the components in the second housing space 11b, a spindle assembly is used that could be driven, for example, with a stepper motor. Here, however, lubrication is required for the spindle. This can lead to contamination of the medium 40 to be controlled, as shown in FIG. 1.

All of the constructions of the drive device 10, the valve 1, and the system 60 described above in connection with the first to third embodiment can be used individually or in combination. In particular, the following modifications are conceivable for all embodiments.

The dimensions of the parts shown in FIGS. 1 to 3 are arbitrary as long as the function of these parts described above can be achieved. For example, the metal part 19, the coil carrier 18, and the coils 17a, 17b, 17c, 17d do not have to be adapted in length exactly to the length of the second housing space 11b, but instead could also be dimensioned shorter than the second housing space 11b.

The housing 11 can be made from corrosion-resistant stainless steel, advantageously austenitic stainless steel, or plastic, advantageously corrosion-resistant plastic. The drive rod 14 can be made from a paramagnetic or diamagnetic material, such as austenitic stainless steel or a non-ferrous metal. The pole shoes 22 can have a cylindrical shape and can be made from a soft-magnetic steel. The permanently magnetic elements 16a, 16b, 16c and the other permanently magnetic element 20 can be made from hard ferrite, SmCo (rare earths), or NdFeB. The metal part 19 can have a solid or plated construction as a pipe made from a soft-magnetic material, for example, iron. The coil carrier 18 is, in the simplest case, a pipe made from plastic.

The coils 17a, 17b, 17c, 17d can also be connected electrically to the control device 12 with more than one connection wire.

The bearings 22a, 22b can be, for example, linear roller bearings or anti-friction bearings.

The assembly including the drive rod 14, the pole shoes 15a, 15b, 15c, 15d, and the permanently magnetic elements 16a, 16b, 16c must have a non-rotationally symmetric shape. In such a case, an anti-rotational device is also useful, in order to protect the drive rod 14, the pole shoes 15a, 15b, 15c, 15d, and the permanently magnetic elements 16a, 16b, 16c from rotation.

In the coil arrangement on the coil carrier 18, temperature sensors or switches can also be embedded with whose help the assembly in the second housing space 11b is monitored and protected against overheating.

The at least one winding of the coils 17a, 17b, 17c, 17d has a single-phase construction that can be operated with a very simple control device 12. According to the required axial force, fewer than four or also additional coils can be added on the coil carrier 18 and connected in series, as well as fewer than three additional permanently magnetic elements 16a, 16b, 16c or magnetizable soft-magnetic elements and four pole shoes can be added on the drive rod 14. The number of coils on the coil carrier 18 and the permanently magnetic or soft-magnetic elements and the pole shoes on the drive rod 14 is oriented only according to the stroke required for the shut-off body 33 of the valve block 30 for opening the valve 1.

The shut-off body 33 can be a piston, a ball, a needle, etc. Thus, the system formed from the drive device 10 and valve block 30 can have a modular construction and can be adapted and matched to the required axial force range.

For the dimensional body 13a, the grooves can be cylindrical, all-around grooves with a groove width of preferably approx. 0.5 to 2.0 mm. The detecting device 13b can scan the grooves with an induction or magneto-resistive method, preferably with a non-contact method, by a suitable scanning head.

1. Drive device for a valve, comprising
a housing,
a coil that is stationary with respect to the housing located in the housing and
a drive rod on which a pole shoe and a permanently magnetic or magnetizable soft-magnetic element magnetized in an axial direction of the drive rod are mounted such that the drive rod is movable in the housing with a translational motion relative to the coil by a magnetic force,
the drive rod is coupleable with a shut-off body of the valve that is movable with a translational motion such that a translational motion of the drive rod causes a translational motion of the shut-off body for opening and closing the valve.

2. Drive device according to claim 1, further comprising
a metal part that is mounted on the housing and surrounds the coil and an additional coil arranged nearby, wherein the coils are mounted on the metal part and each has at least one winding having a winding direction that is set opposite a winding of the other coil, and
an additional pole shoe and the permanently magnetic or magnetizable soft-magnetic element magnetized in the axial direction of the drive rod are mounted on the drive rod of the pole shoe such that the drive rod is movable with a translational motion into and along the coils by the magnetic force.

3. Drive device according to claim 1, wherein a stroke (H) of the drive rod is produced from a length (L) of the coil in a longitudinal direction (LR) of the drive rod minus a thickness (D) of the pole shoe in the longitudinal direction (LR) of the drive rod.

4. Drive device according to claim 1, further comprising
an additional permanently magnetic or soft-magnetic element that is arranged on the drive rod with a predetermined spacing away from the pole shoe and the permanently magnetic or soft-magnetic element, and
an additional soft-magnetic element that surrounds the additional permanently magnetic or soft-magnetic element.

5. Drive device according to claim 1, wherein the housing is constructed such that it is sealed against ingress of at least one of liquid or gas from outside.

6. Drive device according to claim 2, wherein the permanently magnetic or soft-magnetic element, the two pole shoes, and an additional permanently magnetic or soft-magnetic element are arranged on the drive rod axially symmetric relative to the drive rod.

7. Drive device according to claim 1, further comprising a measuring device for measuring a translational motion performed by the drive rod in the housing, the measuring device is arranged on one end of the drive rod facing away from a coupling with the shut-off body.

8. Drive device according to claim 1, wherein the housing is also constructed for holding a control device for connecting to a bus line by which the control device can receive data for at least one of controlling or regulating the drive device.

9. Valve for controlling at least one of a gas or liquid flow, wherein the shut-off body is movable with a translational motion and is coupled with the drive rod of the drive device according to claim 1, wherein a translational motion of the drive rod causes a translational motion of the shut-off body for opening and closing the valve.
